(19) United States
(12) Patent Application Publication
(10) Pub. No.: US 2007/0136581 A1
(43) Pub. Date: Jun. 14, 2007

(54) Secure authentication facility

(75) Inventors: Robert John Hoghaug, Prior Lake, MN (US); Thomas Andrew Hoghaug, Chanhassen, MN (US)

Correspondence Address: HUGH D JAEGER, P.A., P.O. BOX 672, WAYZATA, MN, 55391-0672, US

(73) Assignee: Sig-Tec

(21) Appl. No.: 11/352,966

(22) Filed: Feb. 13, 2006

Related U.S. Application Data
(60) Provisional application No. 60/653,249, filed on Feb. 15, 2005.
(60) Provisional application No. 60/653,250, filed on Feb. 15, 2005.

(51) Int. Cl. H04L 9/00

(52) U.S. Cl. 713/168

(57) ABSTRACT

Secure authentication facility coordinates user authentication for secure access to systems, software applications, and hardware and software resources. The secure authentication facility provides for user authentication using local or remote authentication devices, to authenticate to local or remote operating system, application software, or other resources. The secure authentication facility sends and receives authentication data by use of secure messaging facility to provide consistent handling of authentication regardless of where the various devices, software, and resources are located. The secure authentication facility comprises a DLL. A developer kit is provided to facilitate use of the secure authentication facility. The invention includes software for facilitating user authentication, and includes methods of providing user authentication.

### CROSS REFERENCES TO RELATED APPLICATIONS

This application claims benefit from the earlier filed U.S. Provisional Application No. 60/653,249 filed Feb. 15, 2005, entitled “Software Authentication Facility”, and is hereby incorporated into this application by reference as if fully set forth herein.

This patent application is also related to U.S. Provisional Application No. 60/643,029 filed Jan. 11, 2005, entitled “Multiple User Desktop Graphical Identification and Authentication”; U.S. Provisional Application No. 60/653,250 filed Feb. 15, 2005, entitled “Software Messaging Facility System”; and U.S. utility application entitled “Secure Messaging Facility System” (Attorney Docket P601), filed concurrently herewith, application number to be assigned, a copy of which is attached and the disclosure of which is incorporated herein by reference.

### BACKGROUND OF THE INVENTION

1. Field of the Invention

The present invention relates to a method, software, and system for computer workstation security, and more particularly, an authentication system for user access to a computer workstation or computer network access point.

2. Description of the Prior Art

Computer workstations, nodes, network access points, and the like, commonly use Microsoft Windows® operating systems to provide for secure authentication and access to secure applications, networks, and resources. However, the prior art Microsoft Windows operating systems do not provide a consistent module for secure methods of authentication into a variety of local or remote user and system mode applications.

In addition, the prior art Microsoft Windows operating systems do not support biometric or proximity authentication in the latest versions of 32 bit and 64 bit operating systems, including Windows 2000 Workstation, Windows 2000 Server, Windows XP Home, Windows XP Professional, and Windows 2003 Server. Further, the prior art Microsoft Windows operating systems do not provide for remote applications to use local authentication devices, or for local applications to use remote authentication devices. The prior art Microsoft Windows operating systems also do not provide a simple consistent Application Programming Interface (API) to perform authentication using the various authentication devices. The only strong authentication provided for in the prior art Microsoft Windows operating systems is the use of smart cards for user logon, and this is only supported by Windows 2000 Professional, Windows 2000/2003 Server and Windows XP Professional when they are joined to a domain. The logging of the authentication process provided by the prior art Microsoft Windows operating systems is not very detailed and is not easily configured. Finally, the prior art Microsoft Windows operating systems do not provide a software adaptation functionality that can be used to adapt user applications to enhanced authentication such as local and remote applications and authentications devices, multiple users, enhanced strong authentication, domain or non-domain authentication, and enhanced authentication and event logging.

### SUMMARY OF THE INVENTION

The present invention is a secure authentication facility. The secure authentication facility comprises a dynamic link library (DLL) which can be used by other software to verify a user's credentials to a computer operating system. The secure authentication facility overcomes shortcomings of the prior art authentication and is capable of providing a flexible, efficient and easily extensible method of performing the user authentication process for system and user mode applications running under the Microsoft Windows NT/2000/2003/XP based 32 bit and 64 bit operating systems using a variety of local or remote authentication devices. The present invention includes methods of authentication. The present invention also includes software. The present invention further includes methods and software for configuring user software to utilize enhanced authentication.

The general purpose of the present invention is to provide an easy method of performing authentication and password synchronization. The secure authentication facility also provides detailed logging of the entire authentication process. The secure authentication facility can be used by applications running on thin clients, terminal services, and hand held devices that require authentication using a local device. The secure authentication facility can also be used with non-Microsoft based operating systems by treating these systems as remote authentication devices that it can communicate with over TCP/IP or other various standard and non-standard information protocols.

One significant aspect and feature of the present invention is that it provides a software development application for programmers to add secure user identification and authentication to their applications without the task of creating and integrating all new programming code.

Another significant aspect and feature of the present invention is the ability to incorporate various types of authentication such as using passwords, tokens, SecurID, proximity devices, and various types of biometric authentication devices such as fingerprint or other body feature scanner, sensor, or recorder, voice recognition, and other authentication devices as may become available.

A further significant aspect and feature of the present invention is the ability of the developer to use the invention to create a true multifactor authentication using multiple authentication means or devices.

Still another significant aspect and feature of the present invention is that the invention may be used in developing authentication in Microsoft Windows NT/2000/2003/XP operating environments, and other operating environments including non-Microsoft operating environments, as well as being used in thin clients, terminal services, hand held devices and other such devices.

Having thus described embodiments and significant aspects and features of the present invention, it is the principal object of the present invention to provide a software solution for secure authentication of a user or users on a workstation, server or other device.

### BRIEF DESCRIPTION OF THE DRAWINGS

Other objects of the present invention and many of the attendant advantages of the present invention will be readily appreciated as the same becomes better understood by reference to the following detailed description when considered in connection with the accompanying drawings, in which like reference numerals designate like parts throughout the figures thereof and wherein:

FIG. 1 is a block diagram illustrating the present invention and its interactions with various other authentication devices, software programs, files, and messages; and,

FIG. 2 is a flowchart further illustrating the interactions of the present invention with local and remote authentication devices, software programs, and files by utilizing a Secure Messaging Facility.

### DETAILED DESCRIPTION OF THE PREFERRED EMBODIMENTS

The present invention is a secure authentication facility which overcomes problems of the prior art authentication methods and software. Prior art operating systems typically incorporate some type of user authentication; other third-party software can also provide some type of user authentication. However, the prior art operating systems and authentication methods and software, such as prior art Microsoft Windows operating systems, do not provide a consistent module for secure methods of authentication into a variety of local or remote user and system mode applications. In addition, the prior art Microsoft Windows operating systems do not support biometric or proximity authentication, provide strong authentication only in some versions and only when they are joined to a domain, and only by the use of smart cards for user logon. The prior art operating systems do not provide for remote applications to use local authentication devices, or for local applications to use remote authentication devices. The present invention overcomes these shortcomings of the prior art, as well as providing for an improved, more detailed and configurable logging of the authentication process. The present invention also provides a simple consistent Application Programming Interface (API) to perform authentication using the various authentication devices. Further, the present invention provides a software adaptation functionality that can be used to adapt user applications to enhanced authentication such as local and remote applications and authentications devices, multiple users, enhanced strong authentication, domain or non-domain authentication, and enhanced authentication and event logging.

The present invention secure authentication facility solves the problems of the prior art, and provides a flexible, efficient and easily extensible method of performing the user authentication process for system and user mode applications running under the Microsoft Windows NT/2000/2003/XP operating systems using local or remote authentication devices. The present invention can be adapted to enhance other operating systems, including non-Microsoft Windows operating systems as well.

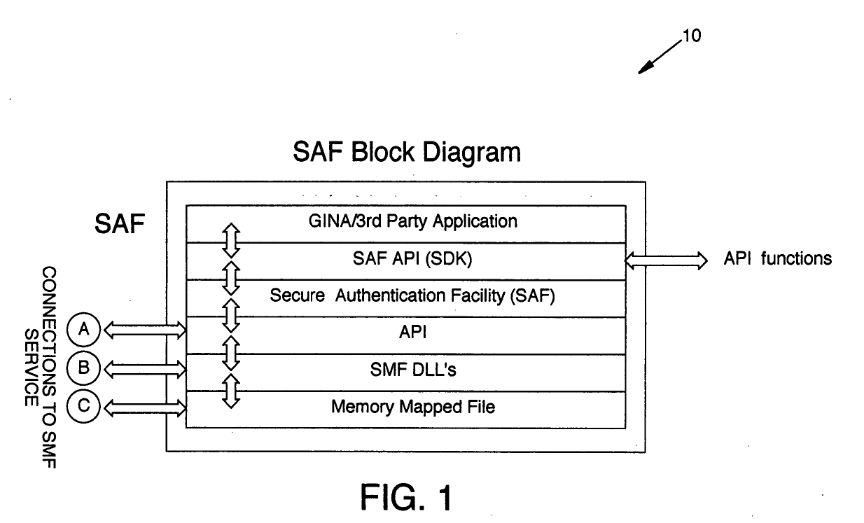

In at least one embodiment, the present invention secure authentication facility 10 comprises software adapted to perform various authentication functions, as illustrated in FIG. 1. In this embodiment, the secure authentication facility comprises a loadable dynamic link library (DLL) accessible by operating system or user application software. The secure authentication facility interacts with authentication devices to obtain user credentials, and passes user credentials to the operating system or user application software. The secure authentication facility is compatible with a variety of authentication devices, including, but not limited to, passwords, tokens, SecurID, proximity devices, and various types of biometric authentication devices, such as fingerprint or other body feature scanner, sensor, or recorder, voice recognition, and other authentication devices as may become available, and with drivers required for their use. The secure authentication facility can pass credentials to and from operating system components, other DLLs, and proprietary authentication software, as well as application software. For example, a graphical identification and authentication (GINA), whether the standard component of Windows or other GINA such as a multiple-user GINA can utilize the secure authentication facility to coordinate user authentication.

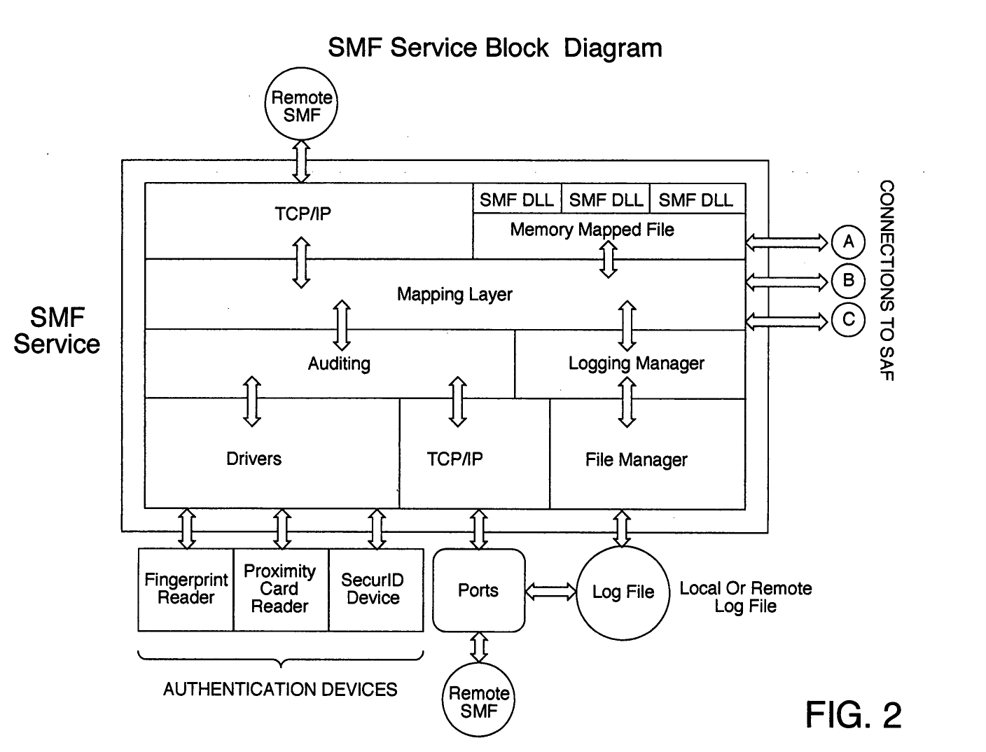

In at least one embodiment, the secure authentication facility coordinates user authentication by use of a secure messaging facility, as illustrated by FIGS. 1 and 2. The secure authentication facility can coordinate such authentication when the authentication device is located locally, or remotely, or multiple devices in any combination of local and remote location, and can provide authentication for operating system or user application software or other computer resource regardless of whether such resource(s) are local and/or remote.

In at least one embodiment, the secure authentication facility utilizes secure messaging facility DLLs and memory mapped files to coordinate user authentication among the various GINA, operating system, application software, ports, and authentication devices. Various types of ports can be utilized to access remote resources, such as by using TCP/IP or other protocols, and by passing authentication data in the form of messages utilizing a secure messaging facility, the secure authentication facility can provide and coordinate user authentication functions among local and/or remote resources.

In at least one embodiment, the secure authentication facility creates and maintains a detailed log file of key authentication events and status history.

In at least one embodiment, the secure authentication facility comprises a published application programming interface (API). In this embodiment, a software customization or development “kit” is provided to enable convenient use of the secure authentication facility DLL by integrating it functionally with operating system or application software as needed to meet the particular authentication requirements of software developers and users.

The secure authentication facility provides coordination of user authentication in networked and non-networked environments. This overcomes limitations of certain prior art approaches, namely, those which require users and resources to be attached to a domain.

In at least one embodiment, the secure authentication facility dynamic link library (DLL) is designed to run on Microsoft Windows operating systems that are based on, or derived from, Windows 32 bit NT. A DLL is an assembly code module that can be loaded by other modules or applications to add functionality or perform a service. In this embodiment, the secure authentication facility is intended to be loaded by any Microsoft Windows application that requires authentication of a user's credentials to continue to run. An example of an application that would load the secure authentication facility is a replacement graphical identification and authentication (GINA) module. The graphical identification and authentication is responsible for authenticating the user who is attempting to logon to the Windows NT based system. The secure authentication facility is specifically designed to return success or failure notices for an authentication and to hide the complexities of using any particular authentication device on which the application relies.

The secure authentication facility frees application developers from the complexities inherent in the use of authentication devices. In the case of biometric devices, the secure authentication facility handles the manipulation of biometric templates controlling the scanning devices and the creation of an association between the authentication device and the user. The secure authentication facility presents a common, customizable user interface making it easy for users and software developers to use. A key feature of the secure authentication facility is its unique ability to be decoupled from the authentication devices. This allows the secure authentication facility to use local or remote devices, loading the application in exactly the same manner, even when the authentication devices and application(s) are not even located on the same system(s).

The secure authentication facility can coordinate authentication very flexibly with respect to the location of the devices. For example, these devices can even be running on non Windows based operating systems. This flexibility makes it possible to use remote authentication devices for local authentication. This flexibility also allows authentication by remote devices for remote application(s) running on a remote server and displaying output on a local system, conveniently providing functionality which was heretofore awkward or unavailable. For example, if a logon session running on a remote server and displayed in a terminal services client window requires authentication, it may request the use of a local (to the terminal services client) biometric scanner. In this way, a user may authenticate using strong authentication on a client machine even though the actual authentication information is for a remote server. Another example would be the use of a remote authentication device being used to obtain credentials and these credentials then being used to validate a user to the remote system. This is accomplished by sending the authentication information from the remote device to the local secure authentication facility located on a Windows NT based system, for example, and then the secure authentication facility validates theses credentials and returns an affirmative or negative response. This in turn allows the remote system to determine whether or not to perform a task, based on this response from the secure authentication facility.

The secure authentication facility is uniquely capable of using remote devices for authentication of local applications or using local devices for authentication to remote applications. Historically, this is accomplished in only a limited manner on Microsoft Windows systems for a limited set of applications and limited to several vendors of terminal services, such as CITRIX, allowing for the use of a very limited set of hardware components. This is all accomplished by an extremely complex and cumbersome method of mapping the local hardware devices to the remote system. In contrast, the present invention secure authentication facility uses a clean message-based architecture that allows it to load the message facility software and by means of the messaging interface contact local and remote systems and communicate with the hardware. The secure authentication facility does not require device mapping, and applications need not even be “aware” that they are running on a remote system(s). The secure authentication facility provides remote systems with the ability to utilize authentication provided by the secure authentication facility in order to determine which tasks may be run and by which users. The secure authentication facility is fully capable of synchronizing authentication credentials such as passwords with the authentication authority (which is typically the local workstation or a Windows domain server).

In another embodiment, the secure authentication facility is designed to run on operating systems other than Windows NT based operating systems.

Other embodiments of the present invention comprise methods of providing user authentication. One such method provides for user authentication utilizing remote authentication device(s). Another such method provides for user authentication for remote applications and resources.

### Mode of Operation

The secure authentication facility comprises a loadable dynamic link library (DLL) intended to be used by other proprietary software and/or other third party programs to accomplish the task of verifying a user's credentials to an operating system so that they may execute secure tasks on that system. Preferably, the operating system is a Windows NT/2000/2003/XP based operating system, although other operating system compatibility is envisioned. Authentication devices may be located on the local system or they may be located on a remote system as the software authentication facility treats these devices the same way. The application programming interface (API) to the secure authentication facility is published, making it easy for third party developers to use the DLL. The secure authentication facility will work in networked and in stand-alone environments (non-networked).

The secure authentication facility does not contact an authentication device directly but does so through other proprietary or third party authentication software. The secure authentication facility sends authentication data in the form of messages to a separate authentication program which in turn contacts the authentication device and returns the appropriate information in the form of another message. The secure authentication facility contacts the separate authentication program by means of a secure shared memory interface and is created by the interface library portion of the separate authentication program. This function is loaded by the secure authentication facility when the application is started. This interface library effectively decouples the secure authentication facility from the authentication devices and allows the secure authentication facility to reside on any local or remote system, including both Microsoft and non-Microsoft based operating systems.

Another function of the secure authentication facility is to create the user interface that is presented to the computer user so they may make decisions on what form of authentication to employ or supply. The secure authentication facility is responsible for requiring the correct information for the authentication device being used. The secure authentication facility makes the decision on which interfaces to display to the user based on the device, the network policies, computer policies and finally in conjunction with settings based on the programmatic and workstation hardware configuration. The secure authentication facility determines availability of devices, Windows domains, and remote authentication, based on the aforementioned configuration and policies. The secure authentication facility is the originator of all credential messages sent to the authentication software and controls the final destination of these messages. The authentication software is simply a resource and the secure authentication facility is essentially the control application.

Various modifications can be made to the present invention without departing from the apparent scope thereof. This description will suggest many variations and alternatives to one of ordinary skill in this art. The various elements described may be combined or modified for combination as desired. All these alternatives and variations are intended to be included within the scope of the claims. Further, the particular features presented in the dependent claims can be combined with each other in other manners within the scope of the invention.

It is claimed:

1. Software for user authentication to access secure computer resource, comprising:
a. a DLL which communicates with user identification and authentication software;
b. said DLL also communicates with at least one authentication device; and,
c. said DLL communicates with the user identification and authentication software and the at least one authentication device by sending and receiving messages via secure messaging facility.

2. The software of claim 1, wherein the user identification and authentication software is located remotely.

3. The software of claim 1, wherein at least one of the at least one authentication device is located remotely.

4. The software of claim 1, wherein at least one of the at least one authentication device is located locally.

5. The software of claim 1, wherein the computer resource is located remotely.

6. The software of claim 1, wherein at least one of the said at least one authentication device is selected from the list consisting of passwords, tokens, SecurID, proximity devices, biometric authentication devices, fingerprint scanner, body feature scanner, body feature sensor, sound recorder, and voice recognition device.

7. The software of claim 1, wherein said DLL is compatible with Microsoft Windows NT/2000/2003/XP based 32 bit and 64 bit operating systems.

8. The software of claim 1, wherein said DLL functions when the user is attached to a domain.

9. The software of claim 1, wherein said DLL functions when the user is not attached to a domain.

10. The software of claim 1, further comprising a software developer kit with an application programming interface to said software.

11. The software of claim 1, wherein at least one of said DLL, the at least one authentication device, the user identification and authentication software, and the secure computer resource is located remotely, and remote communication is accomplished under TCP/IP.

12. A method of user authentication comprising the steps of:
a. providing a DLL which communicates authentication data and coordinates authentication among software and hardware elements;
b. providing a software developers kit for adapting operating system or application software to use of the DLL;
c. using the software developers kit to adapt operating system or application software to access the DLL; and,
d. using the DLL to coordinate user authentication among software and hardware elements.

13. The method of claim 12, wherein at least one of the software and hardware elements are located remotely from the user.

14. The method of claim 13, wherein the DLL communicates authentication data to at least one of the remote software or hardware elements using TCP/IP.
